(19) United States
(12) Patent Application Publication
(10) Pub. No.: US 2024/0161323 A1
(43) Pub. Date: May 16, 2024

(54) COMPONENT MATCHING AND REPORTING SYSTEM AND METHOD

(71) Applicants: Inventec (Pudong) Technology Corporation, Shanghai (CN); INVENTEC CORPORATION, TAIPEI CITY (TW)

(72) Inventors: Ke-Min HU, TAIPEI CITY (TW); Trista Pei-Chun CHEN, TAIPEI CITY (TW); Chun-Hung LIN, TAIPEI CITY (TW); Chun Chieh CHEN, TAIPEI CITY (TW)

(21) Appl. No.: 18/171,332

(22) Filed: Feb. 18, 2023

(30) Foreign Application Priority Data
Nov. 11, 2022 (CN) 202211411946.8

(51) Int. Cl. G06T 7/60; G06T 7/00; G06T 7/73

(52) U.S. Cl. CPC G06T 7/60; G06T 7/001; G06T 7/74; G06T 2207/20084; G06T 2207/30108

(57) ABSTRACT

The present disclosure provides a component matching and reporting method, which includes steps as follows. A 3D file is parsed to obtain features; the features is analyzed according to a feature analysis parameter to find out at least one component feature; it is judged whether the at least one component feature corresponds to a component according to a feature judgment parameter; when the at least one component feature corresponds to the component, the component is located; after the component is located, the component is measured to output a measurement report.

### CROSS-REFERENCE TO RELATED APPLICATION

This application claims priority to China Application Serial Number 202211411946.8, filed Nov. 11, 2022, which is herein incorporated by reference.

### BACKGROUND

### Field of Invention

The present invention relates to systems and methods, and more particularly, a component matching and reporting system and a component matching and reporting method.

### Description of Related Art

The measurement of key components is an important step in the early stage of the product development line to control product quality. The key parts could be a pair of hooks, a screw and a boss or any component that can work in pair. The dimensions of component and distances between components need to be measured to demonstrate that the product is designed with a certain level of safety and quality.

Traditionally, generating a measurement report is a manual process. The steps can be concluded in four main steps. Human operator would 1) open the product design 3D file, 2) localize the key parts, 3) make the section and 4) measure the key part.

However, finding certain kind of structure in 3D space is a challenge for humans. Traversing the entire structure and marking key component locations in the product design file takes time and is dependent on operator experience. Also, making a section for a location is a daunting task for those unfamiliar with the specified 3D tools. Finally, the operator needs to go through the file again and again to ensure that no key parts to be measured are lost. It is tiring and error-prone for operators to make measurement reports for a long time.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

According to embodiments of the present disclosure, the present disclosure provides component matching and reporting systems and component matching and reporting methods, to solve or circumvent aforesaid problems and disadvantages in the related art.

An embodiment of the present disclosure is related to a component matching and reporting method, and the component matching and reporting method includes steps of: parsing a three dimensional (3D) file to obtain a plurality of features; analyzing the features according to a feature analysis parameter to find out at least one component feature; judging whether the at least one component feature corresponds to a component according to a feature judgment parameter; locating the component when the at least one component feature corresponds to the component; and measuring the component to output a measurement report after the component is located.

In one embodiment of the present disclosure, the step of measuring the component to output the measurement report includes: finding at least one measurement face of the component according to a measurement faces rule after the component is located; performing a key part measurement on the at least one measurement face of the component to obtain a measurement data; and applying the measurement data to a report template to generate the measurement report.

In one embodiment of the present disclosure, the component is a hook, and the step of judging whether the at least one component feature corresponds to the component includes: judging whether a face directly faces an opposite face; judging whether an included angle between a chamfer face aimed by an opposite direction of a normal of the face and the normal of the face is in a predetermined angle range; judging whether the face is located on a core plate; and when the face directly faces the opposite face, when the included angle between the chamfer face is in the predetermined angle range, and when the face is located on the core plate, judging that the face corresponds to a hook face of the hook.

In one embodiment of the present disclosure, the component is a hook, and the step of judging whether the at least one component feature corresponds to the component includes: using a neural network model to analyze whether each face in the 3D file is a hook face of the hook.

In one embodiment of the present disclosure, the 3D file comprises two covers, the component is at least one pair of hooks, and the step of judging whether the at least one component feature corresponds to the component includes: shifting the two covers by a preset distance; judging whether there is at least one overlapping portion between the two covers after the two covers are shifted by the preset distance; and judging that the at least one overlapping portion corresponds to the at least one pair of hooks when there is the at least one overlapping portion between the two covers.

Another embodiment of the present disclosure is related to a component matching and reporting system, and the component matching and reporting system includes a storage device and a processor, and the processor is electrically connected to the storage device. The storage device is configured to store a 3D file and at least one instruction. The processor is configured to access and execute the at least one instruction for: parsing a 3D file to obtain a plurality of features; analyzing the features according to a feature analysis parameter to find out at least one component feature; judging whether the at least one component feature corresponds to a component according to a feature judgment parameter; locating the component when the at least one component feature corresponds to the component; finding at least one measurement face of the component according to a measurement faces rule after the component is located; performing a key part measurement on the at least one measurement face of the component to obtain a measurement data; and applying the measurement data to a report template to generate the measurement report.

In one embodiment of the present disclosure, the component is a hook, and the processor is configured to access and execute the at least one instruction for: judging whether a face directly faces an opposite face; judging whether an included angle between a chamfer face aimed by an opposite direction of a normal of the face and the normal of the face is in a predetermined angle range; judging whether the face is located on a core plate; and when the face directly faces the opposite face, when the included angle between the chamfer face is in the predetermined angle range, and when the face is located on the core plate, judging that the face corresponds to a hook face of the hook.

In one embodiment of the present disclosure, the component is a hook, and the processor is configured to access and execute the at least one instruction for: using a neural network model to analyze whether each face in the 3D file is a hook face of the hook.

In one embodiment of the present disclosure, the 3D file comprises two covers, the component is at least one pair of hooks, and the processor is configured to access and execute the at least one instruction for: shifting the two covers by a preset distance; judging whether there is at least one overlapping portion between the two covers after the two covers are shifted by the preset distance; and judging that the at least one overlapping portion corresponds to the at least one pair of hooks when there is the at least one overlapping portion between the two covers.

In one embodiment of the present disclosure, the processor is configured to access and execute the at least one instruction for: lowering a threshold for judging whether the at least one component feature corresponds to the component, so that the measurement report comprises the measurement data of the component and another measurement data of at least one false component.

In view of the above, the component matching and reporting system and component matching and reporting method of the present disclosure can solve or circumvent aforesaid problems and disadvantages in the related art, thereby reducing the possibility of errors and improving the efficiency of time and manpower.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1 is a flow chart of a component matching and reporting method according to some embodiments of the present disclosure; and

FIG. 2 is a block diagram of a component matching and reporting system according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

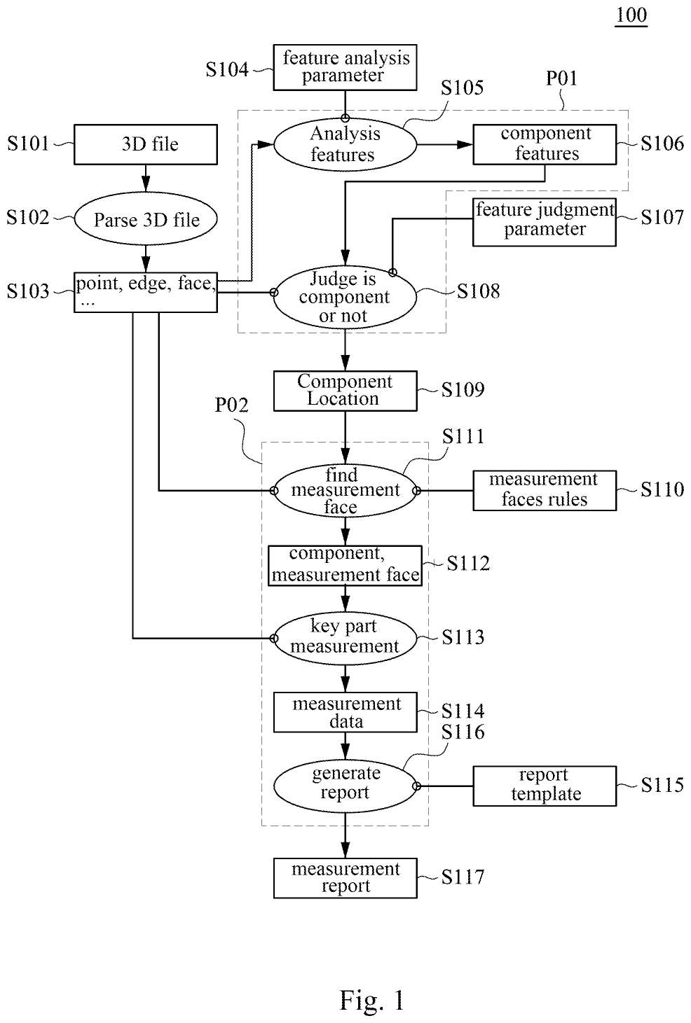

Referring to FIG. 1, in one aspect, the present disclosure is directed to a component matching and reporting method 100. This method may be applied to laptops and may be applicable or readily adaptable to all technologies. Accordingly, the component matching and reporting method 100 has advantages. Herewith the component matching and reporting method 100 is described below with FIG. 1.

The subject disclosure provides the component matching and reporting method 100 in accordance with the subject technology. Various aspects of the present technology are described with reference to the drawings. In the following description, for purposes of explanation, numerous specific details are set forth in order to provide a thorough understanding of one or more aspects. It can be evident, however, that the present technology can be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

For example, a laptop usually consists of four main components, a first cover, a second cover, a third cover, and a fourth cover. The first and second covers are for the screen side and the third and fourth covers are for the keyboard side.

Multiple components are designed on the first and second covers and the third and fourth covers to ensure that the components can be assembled stably. Each component (e.g., a hook) has its own paired partner, called the opposite component (e.g., a opposite hook). The component design spec not only specify the distance range between a pair of components but also the dimensions range of the component.

FIG. 1 is a flow chart of the component matching and reporting method 100 according to some embodiments of the present disclosure. It should be noted that, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

The component matching and reporting method 100 may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

The input of operation S101 of the component matching and reporting method 100 is a 3D file, and the output of operation S117 of the component matching and reporting method 100 is a corresponded measurement report.

As shown in FIG. 1, the component matching and reporting method 100 includes a localization phase P01 and a measurement and generating report phase P02. Before these two main phases, a file parsing process is to parse a three dimensional (3D) file in operation S102, so as to obtain a plurality of features, such as points, edges, faces and so on in operation S103; for example, the plurality of features can be a list of useful property for the process after, e.g., point position, edge position, face position, normal of face, length of edge and so on.

In the localization phase P01, there will be two additional parameters called feature analysis parameters in operation S104 and the feature judgment parameter in operation S107 as input and output the temporary component location data. In operations S104 and S107, the additional parameters are defined based on the target component. Taking hook measurement report as an example, parameters should be defined for hook feature analysis and hook judgment. In the localization phase P01, the features is analyzed according to the feature analysis parameter in operation S105, so as to find out at least one component feature in operation S106; for example, the feature analysis is performed on parsed useful property with analysis parameters and generate component features. Then, in the localization phase P01, operation S108 is to judge whether the at least one component feature corresponds to a component according to the feature judgment parameter, and when the at least one component feature corresponds to the component, the component is located in operation S109; for example. component features with judgment parameters are used to filter and obtain component location data (e.g., a list of component locations). The component location will be one of the input in the measurement and generating report phase P02.

In the measurement and generating report phase P02, there will be two additional materials called measurement face rules in operation S110 and report template in operation S115 as input, and the measurement and generating report phase P02 measuring the component to output a final file of the measurement report. In operation S110, the measurement face rules are usually defined from Mechanical Quality Control Organization who requires the measurement report, and they should be converted to programmable rules from high level human defined ones in operation S111. In operation S112, at least one measurement face of the component is funded according to a measurement faces rules. In operation S113, a key part measurement is performed on the at least one measurement face of the component to obtain a measurement data in operation S115. In operation S116, the measurement data is applied to a report template to generate the measurement report, and the measurement report is outputted in operation S117.

In some embodiments, operation S111 can get the measurement faces those need for measuring the certain components from given component location in operation S109 and programmable rules in operation S110. Gathering with measurement faces and parsed properties in operation S112, operation S113 can calculate those measurement with simple geometry formulas, e.g., Point-Plane Distance, Edge-Edge Distance, Plane-Plane Distance and so on. After operation S114 has the measurement data (e.g., a table of measurement result), we combine the report template and the measurement data to generate a final measurement report.

Then, in some embodiments, taking automation of hook measurement report as an example, the present disclosure propose three kinds of hook localization algorithms, mechanism-based, neural network-based, such as GNN (graph neural network)-based, and intuition-based approach.

Regarding the mechanism-based approach, the present disclosure extract wisdom from expert. There are some mechanism conventions that hook designers usually followed. In some embodiments, the present disclosure converts the conventions into structural description and rules. The present disclosure assumes that each hook should have a datum face (i.e., a hook face) that faces directly to the datum face of its opposite partner. Moreover, each hook has a chamfer face that helps assembling components. Finally, the hook usually stays on the core plate side, the opposite of a cavity plate, which is the inside plate of a product and is usually uneven. Based on the mechanism conventions the present disclosure proposes a set of features: 1. judging whether a face directly faces an opposite face; for example, in nearest n neighbor faces, there is a paralleled face; 2. judging whether an included angle between a chamfer face aimed by an opposite direction of a normal of the face and the normal of the face is in a predetermined angle range (e.g., an acute angle range); for example, with a ray cast from the center and inverse normal of a face, there is a face that is hit and the degree difference between the face normal is in a certain range; 3. judging whether the face is located on a core plate; for example, the normal of the face is similar to the normal of cavity plate, which means it stays on the core plate side. When the face directly faces the opposite face, when the included angle between the chamfer face is in the predetermined angle range, and when the face is located on the core plate, it is judged that the face corresponds to a hook face of the hook.

In the mechanism-based approach, the feature analysis parameters includes coefficients to calculate ray casting from a plane, find a cavity plate and max distance of both opposite face and chamfer face. Consequently, the feature judgment parameters include the acceptable face normal difference range for chamfer face, cavity plate and opposite face.

Regarding the neural network-based (e.g., GNN-based) approach, in some embodiments, taking advantage of the development of machine learning, the present disclosure could formulate the component localization problem into a node classification problem in a graph and using developed graph network framework to solve it. In this neural network-based approach, in some embodiments, each of faces has its own label: hook, or non-hook. Moreover, the lines between the faces are meaning the Edge-Face connection; for example, every two connected faces share an edge. Finally, all the faces and edges have their own properties, like length for edges, area and normal for faces.

In some embodiments, pre-labeled hook faces are represented as the ground truth positive sample (label with hook). We random sample several other faces to be the label of negative sample (label with non-hook). The ratio of positive and negative sample can be controlled.

Then, in some embodiments, the present disclosure can perform neural network-based machine learning framework, using the labeled data. After the well-trained neural network model is get, the present disclosure can get the labeled hook faces with its location by inferencing this model. In some embodiments, in operation S108, the neural network model is used to analyze whether each face in the 3D file is a hook face of the hook.

In this neural network-based approach, the feature analysis parameters and the feature judgment parameters are both defined in labeled data and fine-tuned by machine learning. One of the benefits of this approach is that we don't need to give the exact property required for feature analysis, nor feature judgment thresholds. They can be found and fine-tuned by machine learning with given labeled data.

Regarding the intuition-based approach, in some embodiments, the present disclosure can also formulate feature analysis intuitively. Hooks are a pair of components that function by blocking each other. In other words, if we move the sides of the overlay pair a little bit, the overlap is the hook. Based on this intuition, in some embodiments, in operation S108, the two covers are shifted by a preset distance; after the two covers are shifted by the preset distance, whether there is at least one overlapping portion between the two covers is judged; when there is the at least one overlapping portion between the two covers, it is judged that the at least one overlapping portion corresponds to the at least one pair of hooks.

In some embodiments, every face that live inside the overlapping volume is hook. In this intuition-based approach, the feature analysis parameters are the coefficients of the shift transformation, and the feature judgment parameters are the parameters of the overlap judgment.

Regarding operation S110 of finding the measurement face, in some embodiments, the measurement spec is converted to the faces that the present disclosure needs in measurement then labels the faces. For example, the datum face is the hook face obtained in the localization phase P01; the paralleled faces pair nearest to the hook face, the face with larger angle between the hook face is a first front face, otherwise is a second front face; the back-to-back faces pair nearest to the hook face are first and second side faces; the first interaction face that uses ray-casting from the opposite direction of the normal of the hook face is the chamfer face; The nearest face whose normal is opposite to the normal of the hook face is a top face; the first interaction face that uses ray-casting from the direction of the normal of the hook face is a button face. Accordingly, the present disclosure defines the programmable rules based on the list of faces that the present disclosure needs in measurement. All the processes are programmable.

After operation S112 gets the faces we need in measurement, operation S113 is the section operation to every hook and its related faces to get a 2D sectional view for reporting. Finally, in operation S113, the simple geometry formulas are performed to measure each key point, such as an engagement gap, hook spacing, a hook amount, a tip height, an unhook (height), a hooking length, a hook thickness, a hook thickness to a slide apex, a hook width, a hook height and so on.

For example, the first hook and the second hook can be a pair of hooks engaged with each other, the engagement gap is a plane-plane distance between the hook face of the first hook and the hook face of the second hook, a first hook spacing is a plane-plane distance between the second front face of the first hook and the first front face of the second hook, a second hook spacing is a plane-plane distance between the first front face of the first hook and the second front face of the second hook, the hook amount is a plane-plane distance between the first front face of the first hook and the first front face of the second hook.

For example, for each hook, the tip height is a point-point distance between the first front face's edge endpoints projected on the normal of the button face, the unhook (height) is a point-point distance between the hook face's edge endpoints projected on the normal of the button face, the hooking length is a point-plane distance between the first front face's edge near endpoint to the second front face, the hook thickness is a point-plane distance between the top face's edge far endpoint to the second front face, the hook thickness to the slide apex is a point-plane distance between the top face's edge near endpoint to the second front face, the hook width is a plane-plane distance between the first and second side faces, and the hook height is a plane-plane distance between the top face and the button face.

In operation S116, by given predefined report template and corresponded result data mapping. The present disclosure can automatically generate final report by filling the corresponded data to field in template, so as to generate the final measurement report. For example, the measurement report includes the measurement data of a pair of hooks (such as: the mark number of the pair of hooks, the cross-sectional view, the engagement gap, the hook spacing, the hook amount and so on), and can also include the measurement data of each hook (such as: the mark number of the hook, the cross-sectional view, the tip height, the unhook height, the hooking length, the hook thickness, the hook thickness to the slide apex, the hook width, the hook height and so on).

In a real-world case, hooks, bosses, and other types of key components might be designed in various ways and updated daily. For the system to directly assist the existing environment, in some embodiments, the component matching and reporting method 100 provides a well-designed user interface to assist the operator in viewing the automatically generated results. The following strategies integrate the present disclosure into production.

In some embodiments, the component matching and reporting method 100 lowers a threshold for judging whether the at least one component feature corresponds to the component, so that the measurement report comprises the measurement data of the component and another measurement data of at least one false component. For example, by lowering the threshold for feature judgment, the true positive rate will be increased, resulting in a higher false positive rate; however, the efficiency of finding real components is also comprehensively improved, so that all or almost all real components can be marked. The measurement data of the false components is very easy for the operators to identify; for example, the section is obviously a non-component, the length is a negative value, and so on. For pages with false components due to a high false positive rate, we simply remove them from the generated report manually. People can more easily review 2D results and make corrections by pressing “Delete” in the modern report editor.

In some embodiments, the component matching and reporting method 100 integrating key part location algorithms into the 3D tool. Since the algorithms of the key components in the localization phase P01 are integrated into the 3D tool, operators can quickly get a preview of potential results with markers. By using the preview results, operators can easily unmark wrong results or mark missing key components in the 3D tool. After correction in the localization phase P01, the generated Power Point in the measurement and generating report phase P02 is ready to be reported.

In view of above, the component matching and reporting method 100 finds the hooks in a product 3D structure file automatically. With the hook location information, the measurement can be performed automatically also. The component matching and reporting method 100 gives the report templates, so that a well-written measurement report can be generated automatically. In the component matching and reporting method 100, the automation of processing/labeling 3D structure files helps collecting label data that could be used by others data-driven methods in the future.

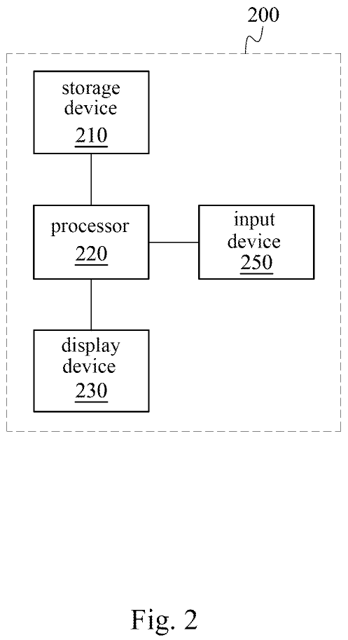

FIG. 2 is a block diagram of a component matching and reporting system 200 according to some embodiments of the present disclosure. As shown in FIG. 2, the component matching and reporting system 200 includes a storage device 210, a processor 220, a display device 230 and an input device 250. For example, the storage device 210 can be a hard disk, flash storage device or other storage media, the processor 220 can be a central processor, controller or other circuits, the display device 230 can be a liquid crystal display device, and input device 250 can be a keyboard, mouse, touch control device or the like. In structure, the processor 220 is electrically connected to the storage device 210, the display device 230 and the input device 250.

In use, the storage device 210 is configured to store the 3D file and at least one instruction. The processor 220 is configured to access and execute the at least one instruction for: parsing a 3D file to obtain a plurality of features; analyzing the features according to a feature analysis parameter to find out at least one component feature; judging whether the at least one component feature corresponds to a component according to a feature judgment parameter; locating the component when the at least one component feature corresponds to the component; finding at least one measurement face of the component according to a measurement faces rule after the component is located; performing a key part measurement on the at least one measurement face of the component to obtain a measurement data; and applying the measurement data to a report template to generate the measurement report. The display device 230 can display the measurement report.

Regarding the mechanism-based approach, in some embodiments, the component is a hook, and the processor 220 is configured to access and execute the at least one instruction for: judging whether a face directly faces an opposite face; judging whether an included angle between a chamfer face aimed by an opposite direction of a normal of the face and the normal of the face is in a predetermined angle range; judging whether the face is located on a core plate; when the face directly faces the opposite face, when the included angle between the chamfer face is in the predetermined angle range, and when the face is located on the core plate, judging that the face corresponds to a hook face of the hook.

Regarding the neural network-based approach, in some embodiments, the component is a hook, and the processor 220 is configured to access and execute the at least one instruction for: using a neural network model to analyze whether each face in the 3D file is a hook face of the hook.

Regarding the intuition-based approach, in some embodiments, the 3D file comprises two covers, the component is at least one pair of hooks, and the processor 220 is configured to access and execute the at least one instruction for: shifting the two covers by a preset distance; judging whether there is at least one overlapping portion between the two covers after the two covers are shifted by the preset distance; judging that the at least one overlapping portion corresponds to the at least one pair of hooks when there is the at least one overlapping portion between the two covers.

In some embodiments, the processor 220 is configured to access and execute the at least one instruction for: lowering a threshold for judging whether the at least one component feature corresponds to the component, so that the measurement report comprises the measurement data of the component and another measurement data of at least one false component. The display device 230 can display the measurement report. The measurement data of the false component is easy to identify, and the user can easily delete the measurement data of the false component through the input device 250.

In some embodiments, the storage device 210 stores the 3D tool, above at least one instructions integrated in the 3D tool, the processor 220 executes the 3D tool to open the 3D file and automatically marks the located components, and the display device 230 displays the marked components in the 3D file, so that operators can quickly get a preview of potential results with markers. By using the preview results, operators can easily unmark wrong results or mark missing key components in the 3D tool.

In view of the above, the component matching and reporting system 200 and component matching and reporting method 100 of the present disclosure can solve or circumvent aforesaid problems and disadvantages in the related art, thereby reducing the possibility of errors and improving the efficiency of time and manpower.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A component matching and reporting method, comprising steps of:
parsing a three dimensional (3D) file to obtain a plurality of features;
analyzing the features according to a feature analysis parameter to find out at least one component feature;
judging whether the at least one component feature corresponds to a component according to a feature judgment parameter;
locating the component when the at least one component feature corresponds to the component; and
measuring the component to output a measurement report after the component is located.

2. The component matching and reporting method of claim 1, wherein the step of measuring the component to output the measurement report comprises:
finding at least one measurement face of the component according to a measurement faces rule after the component is located;
performing a key part measurement on the at least one measurement face of the component to obtain a measurement data; and
applying the measurement data to a report template to generate the measurement report.

3. The component matching and reporting method of claim 1, wherein the component is a hook, and the step of judging whether the at least one component feature corresponds to the component comprises:
judging whether a face directly faces an opposite face;
judging whether an included angle between a chamfer face aimed by an opposite direction of a normal of the face and the normal of the face is in a predetermined angle range;
judging whether the face is located on a core plate; and
when the face directly faces the opposite face, when the included angle between the chamfer face is in the predetermined angle range, and when the face is located on the core plate, judging that the face corresponds to a hook face of the hook.

4. The component matching and reporting method of claim 1, wherein the component is a hook, and the step of judging whether the at least one component feature corresponds to the component comprises:
using a neural network model to analyze whether each face in the 3D file is a hook face of the hook.

5. The component matching and reporting method of claim 1, wherein the 3D file comprises two covers, the component is at least one pair of hooks, and the step of judging whether the at least one component feature corresponds to the component comprises:
shifting the two covers by a preset distance;
judging whether there is at least one overlapping portion between the two covers after the two covers are shifted by the preset distance; and
judging that the at least one overlapping portion corresponds to the at least one pair of hooks when there is the at least one overlapping portion between the two covers.

6. A component matching and reporting system, comprising:
a storage device configured to store a 3D file and at least one instruction; and
a processor electrically connected to the storage device, the processor is configured to access and execute the at least one instruction for:
parsing a 3D file to obtain a plurality of features;
analyzing the features according to a feature analysis parameter to find out at least one component feature;
judging whether the at least one component feature corresponds to a component according to a feature judgment parameter;
locating the component when the at least one component feature corresponds to the component;
finding at least one measurement face of the component according to a measurement faces rule after the component is located;
performing a key part measurement on the at least one measurement face of the component to obtain a measurement data; and
applying the measurement data to a report template to generate a measurement report.

7. The component matching and reporting system of claim 6, wherein the component is a hook, and the processor is configured to access and execute the at least one instruction for:
judging whether a face directly faces an opposite face;
judging whether an included angle between a chamfer face aimed by an opposite direction of a normal of the face and the normal of the face is in a predetermined angle range;
judging whether the face is located on a core plate; and
when the face directly faces the opposite face, when the included angle between the chamfer face is in the predetermined angle range, and when the face is located on the core plate, judging that the face corresponds to a hook face of the hook.

8. The component matching and reporting system of claim 6, wherein the component is a hook, and the processor is configured to access and execute the at least one instruction for:
using a neural network model to analyze whether each face in the 3D file is a hook face of the hook.

9. The component matching and reporting system of claim 6, wherein the 3D file comprises two covers, the component is at least one pair of hooks, and the processor is configured to access and execute the at least one instruction for:
shifting the two covers by a preset distance;
judging whether there is at least one overlapping portion between the two covers after the two covers are shifted by the preset distance; and
judging that the at least one overlapping portion corresponds to the at least one pair of hooks when there is the at least one overlapping portion between the two covers.

10. The component matching and reporting system of claim 6, wherein the processor is configured to access and execute the at least one instruction for:
lowering a threshold for judging whether the at least one component feature corresponds to the component, so that the measurement report comprises the measurement data of the component and another measurement data of at least one false component.
